(19) United States
(12) Patent Application Publication
(10) Pub. No.: US 2018/0336612 A1
(43) Pub. Date: Nov. 22, 2018

(54) SYSTEM FOR THIRD-PARTY ITEM PICKUP AUTHORIZATION

(71) Applicant: Walmart Apollo, LLC, Bentonville, AR (US)

(72) Inventors: Mark Bullard, III, Rogers, AR (US); Anthony G. Wind, III, Gravette, AR (US)

(21) Appl. No.: 15/962,768

(22) Filed: Apr. 25, 2018

Related U.S. Application Data
(60) Provisional application No. 62/508,388, filed on May 18, 2017.

(51) Int. Cl. G06Q 30/06; H04L 9/32

(52) U.S. Cl. CPC G06Q 30/0617; G06Q 30/0609; H04L 9/3234

(57) ABSTRACT

Examples provide an authentication system for authorizing third-party pickup of items. An authentication controller obtains a user-generated token. The user-generated token is associated with an item to be picked up by a third-party user. The authentication controller creates a machine-generated token. The machine-generated token is transmitted to the third-party user. Upon receiving a request to pick up the item from the third-party user, the authentication controller compares tokens provided by the requesting third-party with the user-generated token and the machine-generated token. If the third-party provided tokens are valid, the requesting third-party is authorized to pick up the item and the request is accepted. The item is released to the authorized third-party requester. The item may be released via an item pickup kiosk or a locker system. If the tokens are invalid, the third-party request to pick up the item is rejected. A notification is sent to the user.

### BACKGROUND

Currently, if a customer wants someone else to pick up an order, the customer designates a specific person to pick up the order. At the time of pick up, the third-party is typically required to provide identification or order information regarding the customer, third-party, and/or product to verify the third-party is authorized to receive the product. For example, the third-party may be required to provide personal identification and/or information such as a name, address, telephone number, or email address. Alternatively, other order information may be utilized to verify a third-party, such as a receipt, order number, pick up date, pick up time, or a secret question-answer combination.

The identification or order information is typically checked manually by personnel at the pickup location. This manual verification system is frequently onerous and time consuming for users. Third-party information checks may be less secure or unreliable, resulting in products being released to improper persons, inconvenience to customer, and lost revenue. Moreover, once a person is designated by the customer to pick up the product, it may be difficult or impossible for the user to change the designated person to a different third-party. This may result in pick up delays, order cancellations, and/or customer inconvenience if the person originally designated to pick up the product is unavailable or otherwise becomes unsuitable to pick up the product.

### SUMMARY

Some examples of the disclosure provide an item pickup kiosk for authenticating third-party recipients of items. The item pickup kiosk includes a memory, a processor communicatively coupled to the memory, and a data storage device storing data associated with a plurality of items associated with a plurality of orders. An authentication controller receives a request from a user to obtain a selected item associated with an order. The request includes a set of request tokens. The authentication controller compares the set of request tokens with encrypted authentication data associated with the order to determine whether the set of request tokens correspond with a user-generated token and a machine-generated token in the encrypted authentication data. The authentication controller generates an instruction to release the selected item to the user on condition the set of request tokens correspond with the user-generated token and the machine-generated token. The authentication controller outputs a response rejecting the request to the user via a user interface component if the set of request tokens fail to correspond with the user-generated token and the machine-generated token in the encrypted authentication data. A set of conveyor belts within the item pickup kiosk transfers the selected item from a storage compartment within the item pickup kiosk to a pickup window if the instruction to release the selected item to the user is received from the authentication controller.

Other examples provide a computer-implemented method for authenticating third-party recipients of items. An authentication controller receives authentication information for authenticating a third-party recipient of an item associated with a transaction from a first client device associated with a user via a network. The authentication information includes a first token associated with the transaction and contact data associated with the third-party recipient. The authentication controller compares the first token to account information associated with the user. The authentication controller generates a second token associated with the transaction if the first token fails to correspond with at least a portion of the account information. The second token is different than the first token. A communication interface device transmits the second token to a second client device associated with the third-party recipient based on the contact data. When a request to pick up an item is received from the third-party recipient, the authentication controller extracts a set of request tokens from the request. The requested item is released to the third-party recipient if the set of request tokens correspond to the first token and the second token.

Still other examples provide a locker system for authorizing third-party item pickup requests. The system includes a plurality of item storage lockers storing a plurality of items ready for pick up by at least one user. The system further includes a memory; a processor communicatively coupled to the memory; and a data storage device storing data associated with the plurality of items. An authentication controller receives information for authenticating a user to receive or pick up a selected item stored in at least one item storage locker in the plurality of item storage lockers. The information includes a user-generated token associated with the first transaction and contact data associated with the recipient. The authentication controller transmits a machine-generated token using the contact data. The authentication controller generates encrypted authentication data associated with the transaction. The encrypted authentication data includes the user-generated token and the machine-generated token. The authentication controller receives a request to pick up the item from a client device. The request includes a set of request tokens. The authentication controller compares the set of request token with the encrypted authentication data to determine whether the set of request tokens correspond with the user-generated token and the machine-generated token in the encrypted authentication data. If the set of request tokens correspond with the user-generated token and the machine-generated token in the encrypted authentication data, the authentication controller unlocks the at least one item storage locker in the plurality of item storage lockers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for performing third-party recipient authorization.

FIG. 2 is an exemplary block diagram illustrating an item pickup kiosk.

FIG. 3 is an exemplary block diagram illustrating a locker system.

FIG. 4 is an exemplary block diagram illustrating a front view of an item pickup kiosk.

FIG. 5 is an exemplary block diagram illustrating an authentication server communicating with a set of user devices for authorizing a third-party.

FIG. 6 is an exemplary block diagram illustrating an authentication server having a redemption component for authorizing a third-party recipient.

FIG. 7 is an exemplary block diagram illustrating a data storage device for storing authorization data.

FIG. 8 is an exemplary flow chart illustrating operation of the computing device to generate a set of tokens for authenticating a third-party recipient.

FIG. 9 is an exemplary flow chart illustrating operation of the computing device to replace a set of tokens for authenticating a third-party recipient.

FIG. 10 is an exemplary flow chart illustrating operation of the computing device to generate encrypted authentication data.

FIG. 11 is an exemplary flow chart illustrating operation of the computing device to authenticate a third-party recipient using a set of tokens.

Corresponding reference characters indicate corresponding parts throughout the drawings.

### DETAILED DESCRIPTION

Referring to the figures, examples of the disclosure enable an authentication system for administering a third-party product pick up program. In some examples, an authentication controller receives a user-generated token from a user purchasing a product. The authentication controller creates a machine-generated token. The user-generated token and machine-generated token are provided to a third-party recipient. When the third-party recipient wants to pick up the product, the third-party recipient presents the user-generated token and machine-generated token for authentication. This enables the third-party recipient to pick up items from an item pickup kiosk and/or an item storage locker system without presenting contextual information or personal identification (ID) being presented to improve security of user information and simplify pick up verification procedures.

If the request tokens presented by the third-party recipient are valid, the product is released to the third-party recipient. This two-part authentication system enables a purchaser to securely designate a third-party recipient without providing identification information associated with the third-party recipient.

The purchaser does not specify or identify a specific third-party. This feature enables improved security of both purchaser and recipient information while providing greater flexibility for the purchaser appointing a third-party to pick up products from a retail location, an item pickup kiosk, a locker system, or a product supplier.

Moreover, the user-generated token is generated and/or disseminated independently of the machine-generated token, in other examples. The utilization of two different tokens for authenticating the third-party recipient provides greater security and improved integrity of the authentication system.

Other examples provide a two-form third-party pick up authorization using tokens created and verified without utilization of user information or personal data. This user-generated token is more convenient and flexible for customers, recipients, and merchants.

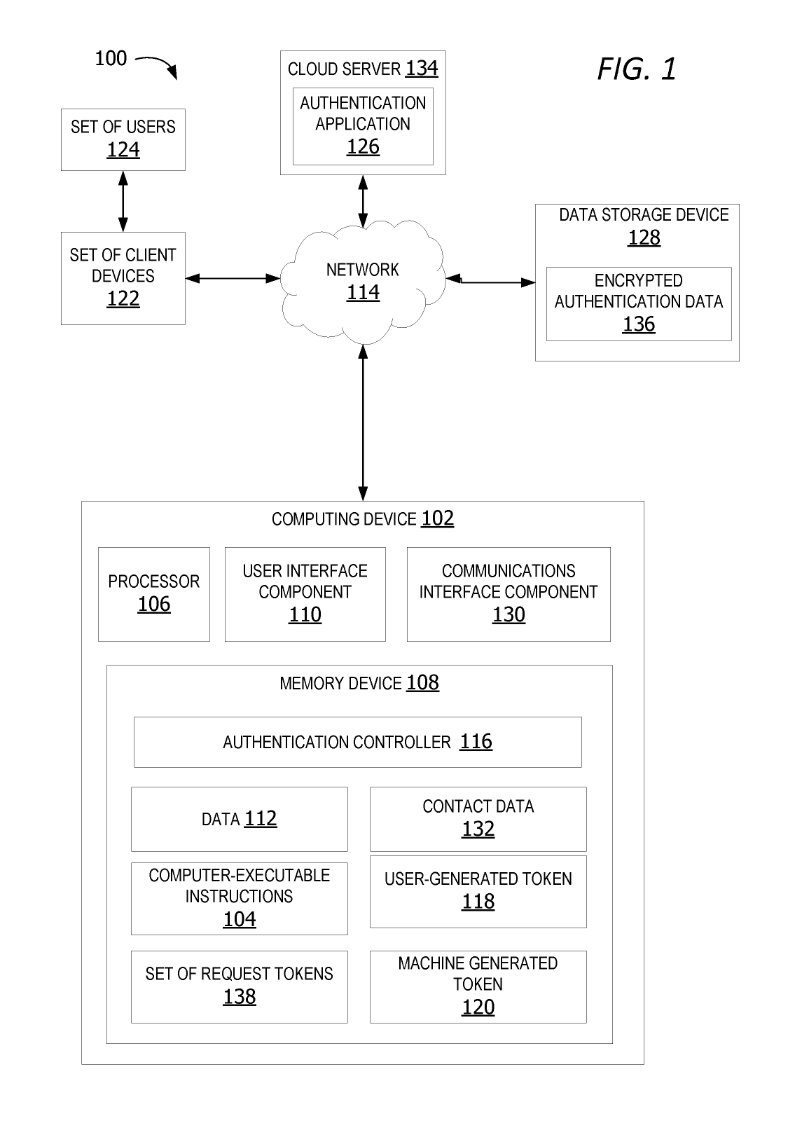

Referring again to FIG. 1, an exemplary block diagram illustrates exemplary block diagram illustrating a computing device for performing third-party recipient authorization. In the example of FIG. 1, a pickup program is administered by a system 100 including the computing device 102 associated with a purchaser. The purchaser is a user in a set of one or more users 124 ordering or otherwise requesting a product to be picked up by the third-party recipient. The third-party recipient is another user in the set of users 124.

Ordering may include purchasing, ordering, borrowing, trading, or otherwise performing a transaction to obtain a product. The purchaser may order the product in-store or remotely from the store via online ordering, mail order, phone ordering, or any other type of ordering.

The computing device 102 represents any device executing computer-executable instructions 104 (e.g., as application programs, operating system functionality, or both) to implement the operations and functionality associated with the computing device 102.

The computing device 102 may include a mobile computing device or any other portable device. In some examples, the mobile computing device includes a mobile telephone, laptop, tablet, computing pad, netbook, gaming device, and/or portable media player.

The computing device 102 may also include less portable devices such as a server, desktop personal computers, kiosks, tabletop devices, industrial control devices, wireless charging stations, and electric automobile charging stations. Additionally, the computing device 102 may represent a group of processing units or other computing devices.

In some examples, the computing device 102 is implemented within an item pickup kiosk for authenticating third-party recipients. If the system authenticates a third-party recipient attempting to pick up one or more selected items that were pre-ordered or pre-paid, a set of conveyor belts and/or a set of robotic arms within the item pickup kiosk transfers the selected item(s) from one or more storage compartments within the item pickup kiosk to a pickup window within the item pickup kiosk. The third-party recipient removes the selected item(s) from the pickup window and takes possession of the selected item(s).

In other examples, the computing device 102 is implemented within an item storage locker system for authentication of third-party recipients of items. If the third-party requesting to pick up of selected item(s) is authenticated by the system, the system unlocks one or more item storage lockers storing the selected item(s) permitting the third-party recipient to remove the item(s) from the locker(s) and take possession of the item(s).

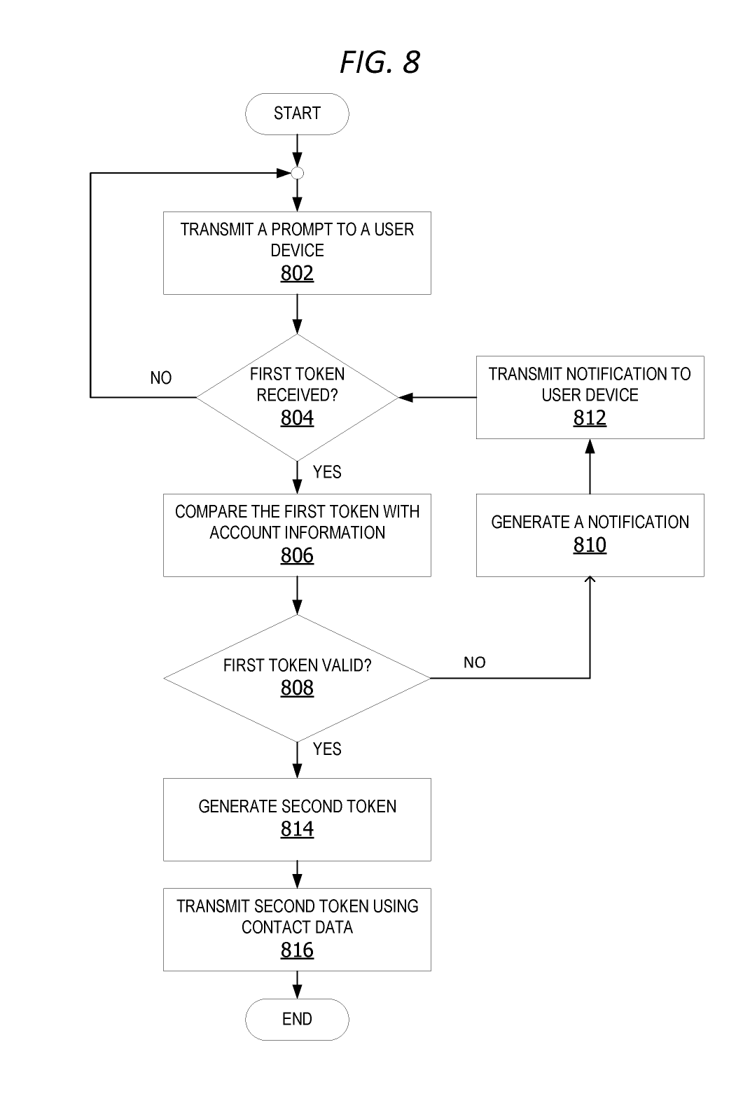

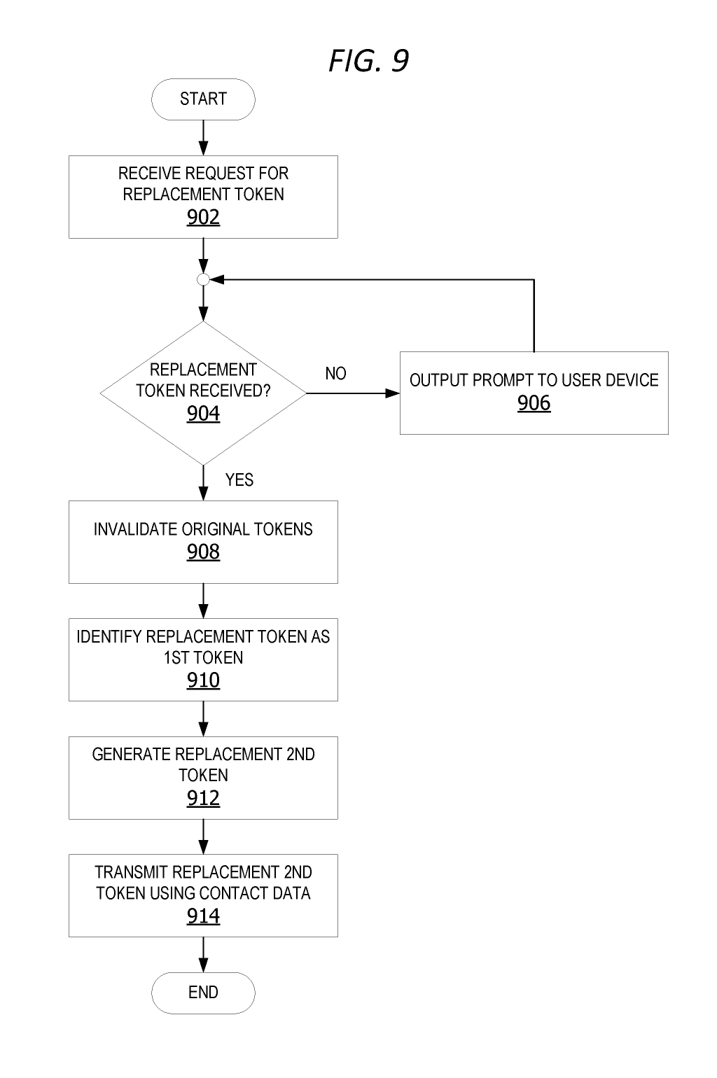

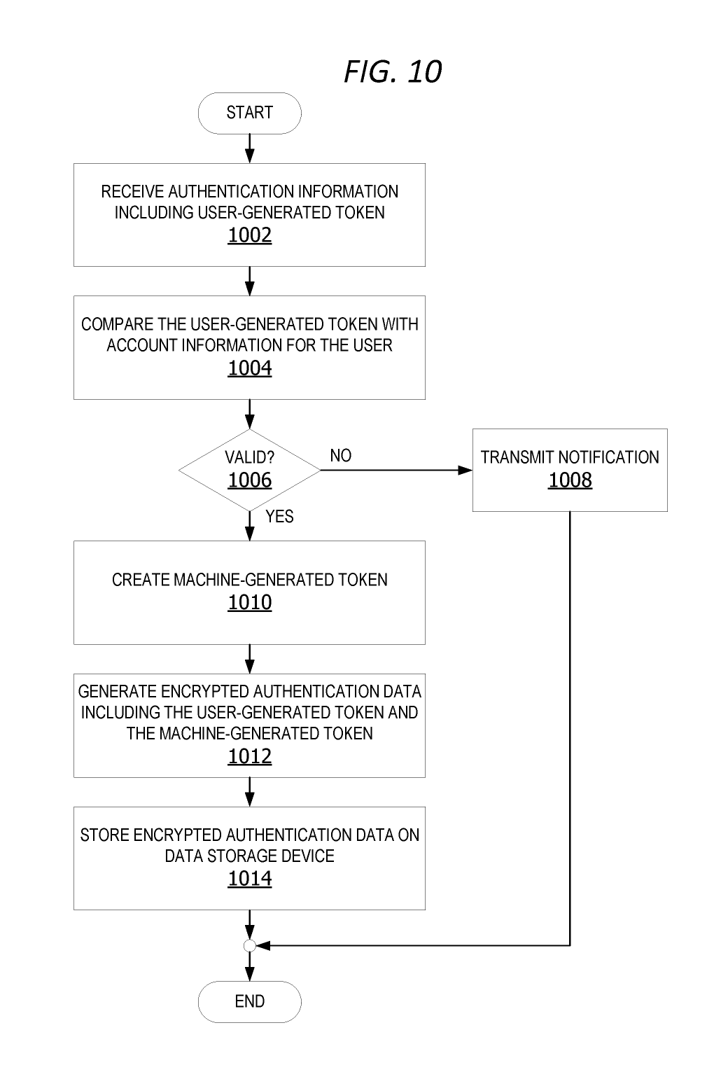

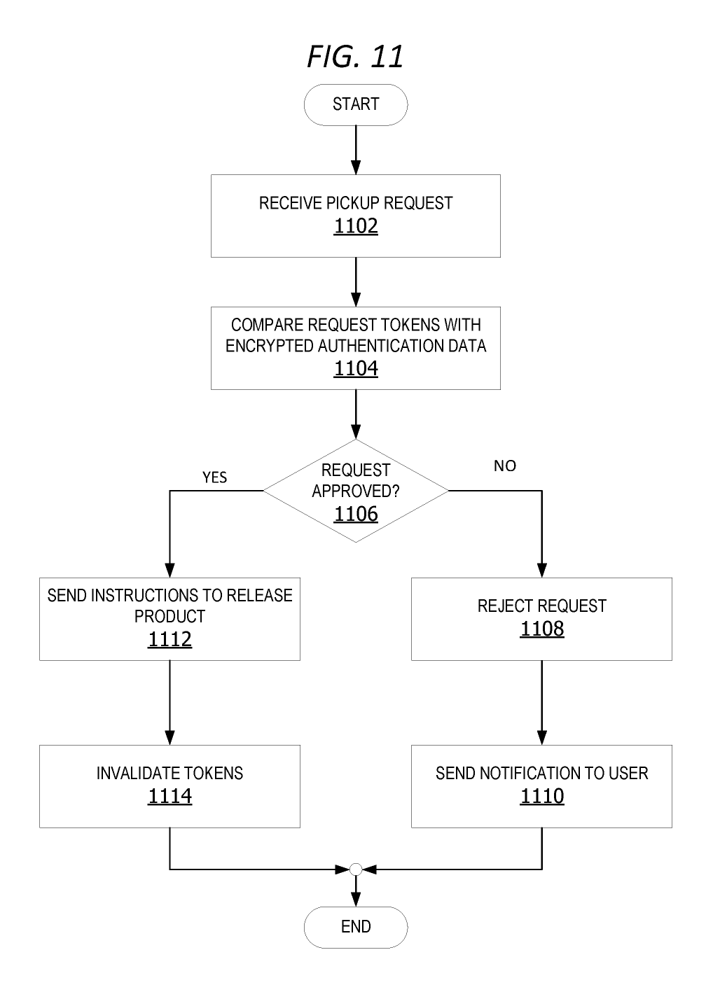

The computing device 102 includes at least one processor 106 and a memory device 108, and at least one user interface component 110. The processor 106 includes any quantity of processing units and is programmed to execute computer-executable instructions 104 for implementing aspects of the disclosure. The instructions may be performed by the processor or by multiple processors within the computing device or performed by a processor external to the computing device. In some examples, the processor is programmed to execute instructions such as those illustrated in the figures (e.g., FIG. 8, FIG. 9, FIG. 10 and FIG. 11) to autonomously authenticate a third-party attempting to pick up an item purchased by a different user via a set of request tokens, thereby improving the functioning of the underlying computing device 102.

In some examples, the processor 106 represents an implementation of analog techniques to perform the operations described herein. For example, the operations may be performed by an analog computing device and/or a digital computing device.

The computing device 102 further has one or more computer readable media such as the memory device 108. The memory device 108 includes any quantity of media associated with or accessible by the computing device 102. The memory device 108 may be internal to the computing device (as shown in FIG. 1), external to the computing device (not shown), or both (not shown). In some examples, the memory device 108 includes read-only memory and/or memory wired into an analog computing device.

The memory device 108 stores data 112, such as one or more applications. The applications, when executed by the processor 106, operate to perform functionality on the computing device 102. The applications may communicate with counterpart applications or services such as web services accessible via a network 114. For example, the applications may represent downloaded client-side applications that correspond to server-side services executing on a cloud server 134 in a cloud.

In some examples, the computing device 102 communicates with one or more other computing devices, such as the set of client devices 122, the cloud server 134, and/or a data storage device 128, via the network 114. The set of client devices 122 is a set of one or more client devices. A client device is any type of computing device, such as, but without limitation, a smart phone, a tablet computing device, a smart watch, a desktop computer, a laptop computer, or any other type of computing device. A client device may be referred to as a user device.

The network 114 is implemented by one or more physical network components, such as, but without limitation, routers, switches, network interface cards (NICs), and other network devices. The network 114 may be any type of network for enabling communications with remote computing devices, such as, but not limited to, a local area network (LAN), a subnet, a wide area network (WAN), a wireless (Wi-Fi) network, or any other type of network. In this example, the network 114 is a WAN accessible to the public, such as the Internet.

The memory device 108 further stores an authentication controller 116. The authentication controller 116, when executed by the processor 106 of the computing device 102, causes the processor 106 to prompt a purchaser in the set of users 124 to provide information for authenticating a third-party recipient of a product associated with the transaction.

The transaction may include any type of transaction to purchase, order, or otherwise obtain a product. The transaction may occur via online shopping, mail order, telephone ordering, or pre-order products not yet available from the manufacturer. The product may include any type of goods, such as, but not limited to, food products, clothing products, electronics, or any other type of product.

The authentication controller 116 is further executed in some examples to cause the processor 106 to receive the information for authenticating the recipient from the purchaser. The information includes a user-generated token 118 associated with the transaction and contact data 132 associated with the recipient. The user-generated token 118 and the contact data 132 are received from the purchaser in a single communication in some examples. In other examples, the user-generated token 118 is received in a first communication and the contact data 132 is received in a second communication from the purchaser. The contact data 132 includes contact information for the third-party recipient.

The authentication controller 116 is further executed to cause the processor 106 to create a machine-generated token 120 associated with the transaction. The user-generated token 118 is different from the machine-generated token 120.

The authentication controller 116 is further executed in some examples to cause the processor 106 to transmit the machine-generated token to the third-party recipient using the contact data. In other examples, the authentication controller 116 transmits the machine-generated token to the purchaser. The purchaser then provides the machine-generated token 120 to the purchaser.

When the product is ready for pickup, the authentication controller 116 identifies a request from a third-party recipient to claim the product. The request includes a set of request tokens 138. The set of request tokens 138 is a set of two or more tokens provided by the third-party recipient. The set of request tokens 138 in this example includes a first request token corresponding to the machine-generated token 120 and a second request token corresponding to the user-generated token 118. The request is approved on condition that the set of request tokens 138 provided in the request are valid.

The authentication controller 116 determines if the set of request tokens 138 are valid by comparing the machine-generated token 120 and the user-generated token 118 to the set of request tokens 138 provided by the third-party recipient. If at least one request token matches the machine-generated token 120 and at least one request token in the request matches the user-generated token 118, then the request tokens are valid, and the request is approved. The user-generated token 118 and the machine-generated token 120 may be stored locally on the computing device 102 or stored on a remote data storage, such as, but not limited to, the data storage device 128. The user-generated token 118 and the machine-generated token 120 may be stored in an encrypted or unencrypted state.

In some examples, the machine-generated token 120 is generated by the authentication controller 116 running on the computing device 102. However, in other examples, the machine-generated token 120 is generated by an authentication application 126 running on the cloud server 134. The authentication application 126 transmits the machine-generated token 120 to the computing device 102. In other examples, the authentication application 126 transmits the machine-generated token 120 to at least one client device in the set of client devices 122 associated with a product purchaser and/or the third-party recipient to pick up the product.

In some examples, the computing device 102 optionally includes a communications interface component 130. The communications interface component 130 includes a network interface card and/or computer-executable instructions (e.g., a driver) for operating the network interface card. Communication between the computing device 102 and other devices, such as the set of client devices 122, the cloud server, and/or the data storage device 128, may occur using any protocol or mechanism over any wired or wireless connection. In some examples, the communications interface is operable with short range communication technologies such as by using near-field communication (NFC) tags.

In some examples, the user interface component 110 includes a graphics card for displaying data to one or more users and/or receiving data from the one or more users. The user interface component 110 may also include computer-executable instructions (e.g., a driver) for operating the graphics card. Further, the user interface component 110 may include a display (e.g., a touch screen display or natural user interface) and/or computer-executable instructions (e.g., a driver) for operating the display. The user interface component 110 may also include one or more of the following to provide data to a user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a way.

In some examples, the user is a purchaser of a product. The purchaser provides the user-generated token 118 via the user interface component 110. In other examples, the third-party recipient provides the user-generated token and/or the machine-generated token to the authentication controller via the user interface component 110.

The computing device 102 optionally stores data on one or more data storage devices, such as, but without limitation, data storage device 128. The data storage device 128 is a remote data storage device for storing data, such as transaction data, user account data, or any other data associated with a transaction. The data storage device 128 may include one or more databases and/or filesystems.

The authentication controller 116 in some examples stores encrypted data, such as encrypted authentication data 136, on the data storage device 128. The authentication controller 116 encrypts the user-generated token 118 and the machine-generated token 120. The encrypted user-generated token 118 and machine-generated token 120 in some examples is stored on the data storage device 128 as encrypted authentication data 136. The encrypted authentication data 136 includes the encrypted user-generated token 118 and machine-generated token 120.

In this example, the encrypted authentication data 136 is stored on a remote data storage. In other examples, the encrypted authentication data 136 is stored locally to the computing device 102. In still other examples, the encrypted authentication data 136 is stored on a cloud storage, such as cloud server 134.

The authentication controller 116, in some examples, analyzes transaction data associated with the transaction to identify a client device associated with the purchaser and/or the third-party recipient. The transaction data may include information associated with the transaction, product being purchased, pickup location of the product, date of pick up, time of pick up, and/or other data associated with the transaction.

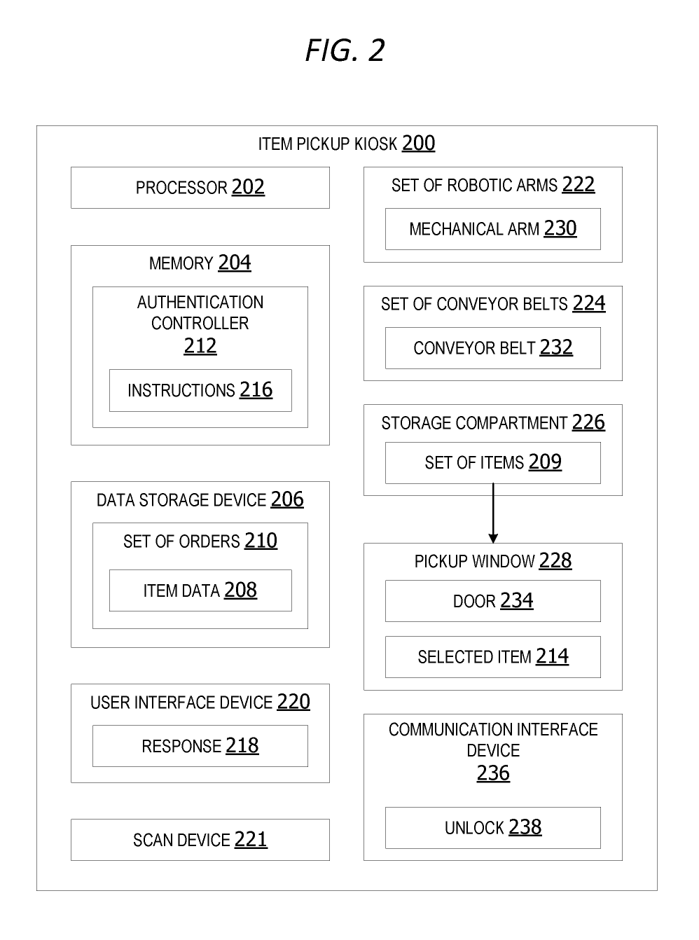

FIG. 2 is an exemplary block diagram illustrating an item pickup kiosk 200. The item pickup kiosk 200 includes a processor 202 communicatively coupled to a memory 204. The processor 202 may include one or more processors, such as the processor 106 in FIG. 1. The memory 204 may be implemented as a memory, such as, but not limited to, the memory device 108 in FIG. 1.

A data storage device 206 in some examples stores data, such as, but not limited to, item data 208 associated with a set of items 209 ordered, pre-paid, or purchased online via a set of orders 210. The set of items 209 includes one or more items. The data storage device 206 may include one or more data storage devices, such as, but not limited to, the data storage device 128 in FIG. 1.

An authentication controller 212 receives a request from a user to obtain a selected item associated with one or more orders in the set of orders 210. The authentication controller 212 is a component for authenticating a request by a first user to pick up an item ordered by a second user using a set of tokens, such as, but not limited to, the authentication controller 116 and/or the authentication application 126 in FIG. 1.

The request includes a set of request tokens. The request may be provided by the user via a user interface device 220 and/or via a scan device 221. The user interface device 220 is an interface permitting a user to receive data or input data, such as, but not limited to, the user interface component 110 in FIG. 1.

In some examples, the user scans an order identifier on a display screen of a client device using the scan device 221. The order identifier may include an electronic receipt or code displayed on a smart phone, tablet, smart watch or other portable (mobile) user computing device. The order identifier in some examples may include a quick response (QR) code, a universal product code (UPC), a matrix barcode, or any other type of identifier.

In other examples, the user scans a barcode or other order identifier on an order printout or other hardcopy, such as a paper receipt to enter one or more of the request tokens. In other examples, the user manually enters one or more of the tokens via the user interface or other input device, such as a touchscreen, speaker, keyboard, the scan device 221 or any other input device.

The authentication controller 212 compares the set of request tokens with encrypted authentication data associated with the order to determine whether the set of request tokens correspond with a user-generated token and a machine-generated token in the encrypted authentication data. The authentication controller 212 generates an instruction 216 to release the selected item 214 to the user if the set of request tokens correspond with the user-generated token and the machine-generated token. The authentication controller 212 outputs a response 218 rejecting the request to the user via a user interface device 220 if the set of request tokens fail to correspond with the user-generated token and the machine-generated token in the encrypted authentication data.

A set of robotic arms 222 and/or a set of conveyor belts 224 within the item-pickup kiosk 200 autonomously transfers the selected item 214 from a storage compartment 226 within the item-pickup kiosk 200 to a pickup window 228 associated with the item-pickup kiosk if the instruction 216 to release the selected item 214 is generated by the authentication controller 212 and/or received by a pickup window controller device.

The set of robotic arms 222 in some examples includes one or more arms, such as mechanical arm 230. The set of robotic arms 222 move, lift, push, pull, lift, or otherwise manipulate one or more items to transfer the items from the storage compartment 226 within the item pickup kiosk 200 to the pickup window 228 for removal/pickup by the user. The item may be presented to the user on a tray or other platform within the item pickup window 228.

The set of conveyor belts 224 in other examples includes one or more conveyor belts, such as the conveyor belt 232. The set of conveyor belts move or carry one or more items to transfer the one or more items from the storage compartment 226 within the item pickup kiosk 200 to the pickup window 228 for removal/pickup by the user. In some non-limiting example, the pickup window 228 may include a door 234. The door 234 may slide open to permit the user to remove the selected item 214 from the pickup window 228. In another example, the door 234 may unlock/swing open on a hinge to permit the user to remove the item from the pickup window 228.

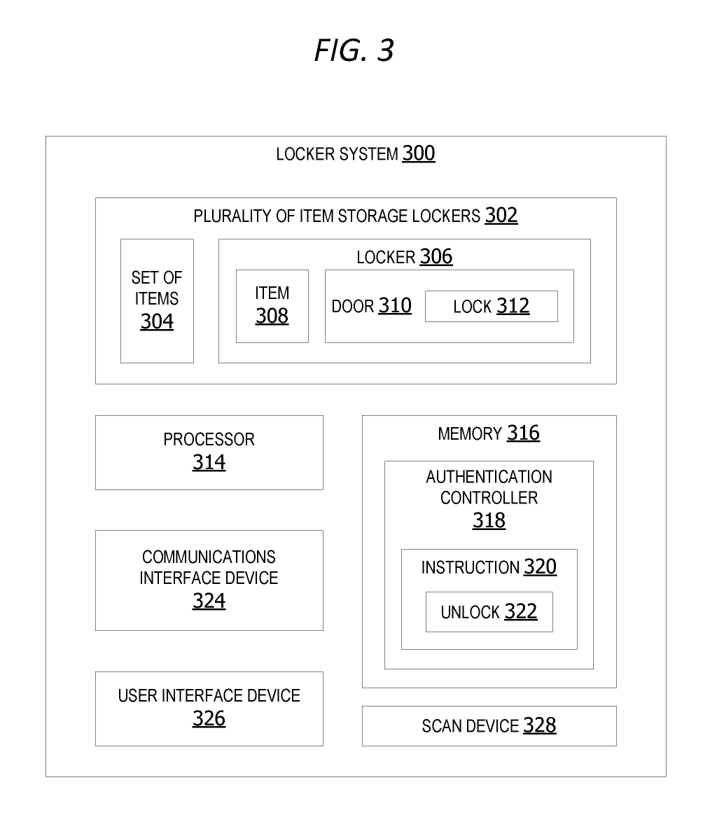

In other examples, if the selected item 214 is too large to fit within the storage compartment 226 and/or the pickup window 228, the selected item 214 may be stored within an item storage locker. In these examples, the authentication controller 212 transmits an instruction to unlock the item storage locker storing the selected item 214 if the third-party user is authorized to receive the selected item 214. The item storage locker unlocking instruction may be transmitted to the appropriate item storage locker via a communication interface device 236, such as, but not limited to, the communications interface component 130 in FIG. 3.

FIG. 3 is an exemplary block diagram illustrating a locker system 300. The system 300 includes a plurality of item storage lockers 302 storing a set of one or more items 304 ready for pickup by at least one user. A locker 306 in the plurality of item storage lockers 302 is a compartment for storing an item 308 having a door 310 and a lock 312. If the third-party user is authorized to receive the item 308, the system 300 unlocks the door 310 to enable the third-party user to remove the item 308 from the locker 306.

The locker system optionally includes a processor 314 communicatively coupled to a memory 316. An authentication controller 318 in some examples is a component that receives information for authenticating a user for pickup of the item 308 stored in the locker 306. The information may include a user-generated token associated with a transaction and contact data associated with the third-party recipient. The transaction may include an online order.

The authentication controller 318 receives an item pickup request from the third-party user to obtain the item 308. The request includes the set of request tokens in this example. The authentication controller 318 may receive the set of request tokens via a user interface device 326 and/or via a scan device 328. The user interface device is an interface, such as, but not limited to, the user interface component 110 in FIG. 1.

In some examples, the authentication controller 318 compares the set of request token with the encrypted authentication data to determine whether the set of request tokens correspond with the user-generated token and the machine-generated token in the encrypted authentication data. If the set of request tokens correspond with the user-generated token and the machine-generated token in the encrypted authentication data, the authentication controller 318 generates an instruction 320 to unlock 322 the door 310 of the locker 306.

The locker system 300 in some examples includes a communication interface device 324, such as, but not limited to, the communications interface component 130 in FIG. 1. The locker system 300 may receive the instruction 320 to unlock 322 the locker 306 from an item pickup kiosk, an authentication server, or another remote computing device.

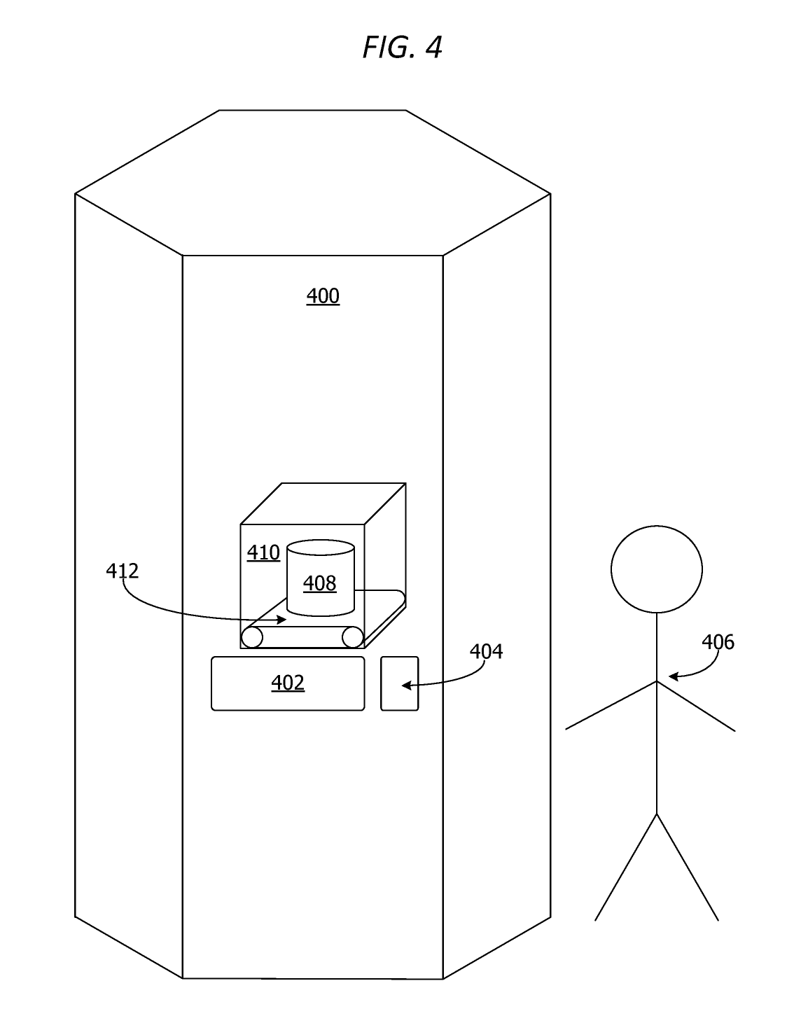

FIG. 4 is an exemplary block diagram illustrating a front view of an item pickup kiosk 400, such as, but not limited to, the item pickup kiosk 200 in FIG. 2. The item pickup kiosk 400 may include a user interface 402, such as, but not limited to, the user interface component 110 in FIG. 1 and/or the user interface device 220 in FIG. 2. The item pickup kiosk 400 may optionally also include a scan device 404 for scanning a barcode, item identifier, or order identifier. In some examples, the user provides the set of request tokens via the user interface 402 and/or the scan device 404.

If the user 406 is authenticated to receive an item 408 stored within the item pickup kiosk, the item 408 is transferred from a storage compartment to a pickup window 410 via a conveyor belt and/or one or more robotic arms (not shown). The user 406 removes the item 408 from the pickup window 410 to take possession of the item 408.

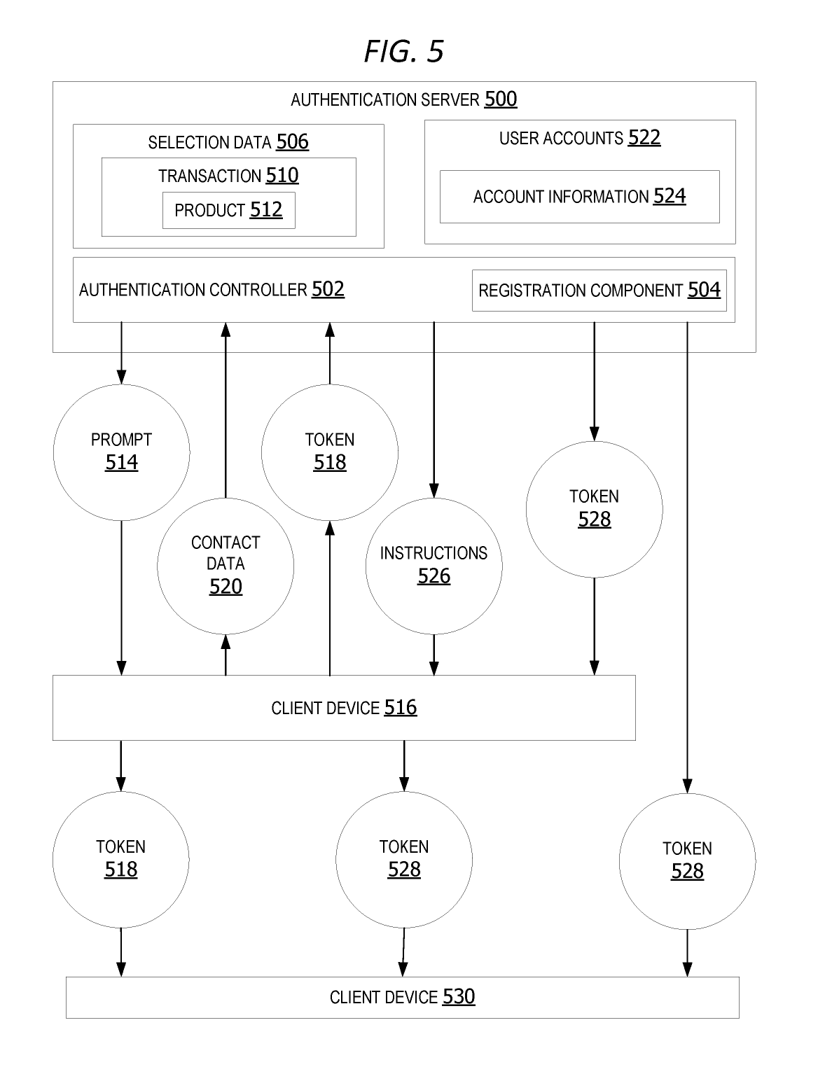

FIG. 5 is an exemplary block diagram illustrating an authentication server communicating with a set of user devices for authorizing a third-party to receive or pick up an item. An authentication server 500 is a computing device including an authentication controller 502, such as computing device 102 in FIG. 1. A registration component 504 of the authentication controller identifies selection data 506. The selection data 506 is data associated with a user that desires to participate in a third-party pickup program. The selection data 506 is provided by a user involved in a transaction to purchase or otherwise obtain a product 512.

The registration component 504 identifies the transaction 510 and the user associated with the selection data 506. The registration component 504 sends a prompt 514 to a client device associated with the user. The prompt 514 is a request for the user to provide information for authenticating a recipient of the product 512.

In some examples, the registration component 504 detects the client device 516. The registration component 504 determines whether the client device 516 is associated with the user corresponding to the transaction 510. On determining the client device 516 is associated with the user, the registration component transmits the prompt 514 to the client device 516 to prompt the user to provide the information.

In this example, the user associated with the client device 516 provides the user-generated token 518 and the contact data 520 to the authentication controller 502. The user-generated token 518 is any type of user created token. In some non-limiting examples, the user-generated token 518 is a passcode, a personal identification number (PIN), or any other type of user created code.

In some examples, the user-generated token 518 does not contain any user account information or other personal identification information. The user-generated token 518 in these examples does not contain real identifiable personal information, such as a name, date, address, email address, or phone number. The user-generated token 518 is a random code or “junk.”

In other examples, the registration component 504 receives the user-generated token 518 from the client device 516 in response to the prompt 514. The registration component 504 sends another prompt 528 to a client device 530 associated with the third-party. The third-party provides the contact data 520. The contact data is data enabling communications with a client device 530 associated with the recipient. In some examples, the contact data 520 includes location data for the selected third-party recipient. The contact data 520 may include an email address, phone number, or other contact information for the recipient.

In this non-limiting example, the client device 516 provides the contact data 520 used by the registration component 504 to send the prompt 528 to the second client device 530. In other examples, the second client device 530 may provide the contact data 520 to the authentication server 500.

Thus, in some examples, the authentication server 500 receives one or more communications from the client device 516 including both the contact data 520 and the user-generated token 518. In other examples, the authentication server 500 receives a first communication including the user-generated token 518 from the first client device 516 and receives a second communication including the contact data from a second client device 530.

For example, when the purchaser associated with the first client device 516 provides the user-generated token, the purchaser may indicate a desire to designate a third-party recipient to pick up the product but choose to delay providing contact data for the third-party recipient. The purchaser in this example provides the contact data via the first client device 516 at the time of purchase. In other examples, the second client device 530 may provide the contact data at another time after the purchase transaction is complete.

In these examples, the contact data sent in a separate communication from the user-generated token. The contact data may optionally be transmitted to the authentication server with a copy of the original user-generated token previously sent from the first client device 516, an order number, or some other identifying information associating the purchaser or order. In these examples, the authentication server 500 transmits the machine-generated token to the third-party recipient using the contact data provided either by the purchaser in the second communication.

In some examples, the registration component 504 identifies one or more user accounts 522 associated with the user and/or the recipient. The registration component 504 compares the user-generated token 518 with account information 524 associated with the one or more user accounts 522 to determine whether the user-generated token 518 corresponds to at least a portion of the account information 524. The registration component 504 utilizes parameters that compare account information with the tokens and recognize attempts to include anything that looks like a date, address, or other identifiable personal information in a user-generated token in some examples.

If the user-generated token 518 corresponds to any account information, the user-generated token is rejected or invalidated. The user is prompted to create a new user-generated token to replace the invalidated token. This protects users against providing any personal or identifying information as part of the user-generated token, to maintain data privacy for the user.

If the user-generated token 518 does not correspond to any account information, the registration component accepts the user-generated token 518. The registration component 504 sends instructions 526 to the client device 516 associated with the user. In some examples, the instructions 526 instruct the user to provide the recipient with the user-generated token 518.

The registration component 504 generates a machine-generated token 528 associated with the transaction. The machine-generated token 528 may be any type of token. In some examples, the machine-generated token 528 includes, without limitation, a passcode, a barcode, a Quick Response (QR) code, or any other type of token. The machine-generated token 528 may be generated using information about the order, such as, but without limitation, the original purchase, items purchases, date purchased, etc.

The registration component 504 in some examples sends the machine-generated token 528 to the client device 516 associated with the user. The user then forwards the machine-generated token 528 to the recipient. In still other examples, the registration component 504 utilizes the recipient contact data 520 to transmit the machine-generated token 528 directly to the client device 530 associated with the recipient. In these examples, the registration component 504 may also send pickup information with the machine-generated token 528. The pickup information informs the third-party recipient they have been selected to pick up the product. The pickup information may also include the pickup location, one or more dates for pick up, and/or pickup time.

In other examples, the user selects whether the authentication controller sends the machine-generated token 528 to the third-party recipient or whether the machine-generated token 528 is only sent to the purchaser. If the purchaser selects an option permitting the authentication controller to send the machine-generated token 528 only to the purchaser, then the purchaser transmits the machine-generated token to the recipient.

In some examples, the registration component 504 receives a request to identify a replacement third-party recipient. For example, the purchaser may designate her son as a third-party recipient to pick up a purchased product. If the purchaser's son becomes ill or otherwise is unavailable to pick up the product as planned, the purchaser may wish to send her daughter to pick up the product instead. The purchaser may request a change in recipient by sending a new user-generated token with replacement contact data for the purchaser's daughter. The authentication server generates a replacement machine-generated token and sends the replacement machine-generated token to the purchaser or to the purchaser's daughter using the replacement contact data.

The replacement user-generated token and the replacement machine-generated token for the second recipient are encrypted and stored as replacement authentication data. The original authentication data, including the original user-generated token and the original machine-generated token for the first recipient is invalidated.

If the request for a replacement third-party recipient does not include a replacement user-generated token, the registration component 504 sends a prompt to the purchaser requesting the purchaser send a replacement user-generated token to the authentication server 500. The registration component 504 generates a new machine-generated token. The original user-generated token 518 and original machine-generated token 528 are invalidated and replaced by the new replacement user-generated token and the new replacement machine-generated token.

The replacement user-generated token in other examples is sent to the registration component with replacement contact data associated with the replacement third-party recipient. The replacement machine-generated token is transmitted to the replacement third-party recipient using the replacement contact data. The original user-generated token and the original machine-generated token are invalidated and replacement by the replacement user-generated token and replacement machine-generated token.

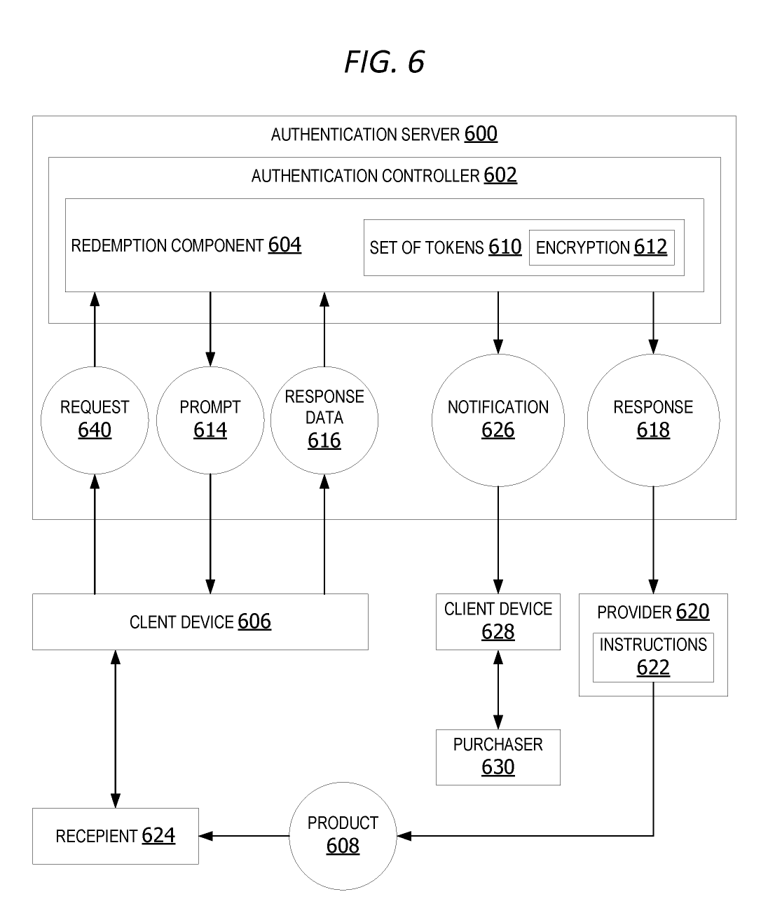

FIG. 6 is an exemplary block diagram illustrating an authentication server having a redemption component for authorizing a third-party recipient 624. An authentication server 600 is a computing device including an authentication controller 602, such as computing device 102 in FIG. 1. A redemption component 604 of the authentication controller 602 identifies a request 640 from a recipient 624 to claim a product 608.

The redemption component 604 in some examples determines whether the request 640 includes a set of request tokens associated with the transaction, such as, but not limited to, the set of request tokens 138 in FIG. 1. The request tokens, to be valid, includes a request token matching the user-generated token and another request token matching the machine-generated token. If the request tokens do not match the corresponding user-generated token and machine-generated tokens for the transaction in the set of tokens 610, the request tokens are invalid.

If the request 640 does not include a set of valid request tokens associated with the transaction, the redemption component 604 sends a prompt 614 to a client device 606 associated with the recipient 624. The prompt 614 is a request for the request tokens corresponding to the user-generated token, the machine-generated token, or both the machine-generated token and the user-generated token. The recipient 624 is a third-party user attempting to pick up the product 608.

The recipient 624 in some examples provides response data 616 including the request tokens in response to receiving the prompt 614. The redemption component 604 compares the request tokens provided by the third-party recipient in the response data 616 with the authentication server's stored copy of the user-generated token associated with the transaction for product 608.

The stored user-generated token in some examples includes encryption 612. In other words, the user-generated token in some examples is an encrypted copy of the user-generated token. The user-generated token may be stored locally on the authentication server 600 or stored on a remote data storage device, such as the data storage device 128 in FIG. 1.

In other examples, the set of tokens 610 includes the machine-generated token and the user-generated token for a given transaction. The user-generated token and machine-generated token may be utilized to generate authentication data. The authentication data for a transaction is a copy of the user-generated token and paired machine-generated token for a transaction. In some examples, the tokens are encrypted and stored as encrypted authentication data, such as, but not limited to the encrypted authentication data 136 in FIG. 1.

The redemption component determines whether the response data 616 corresponds with the stored user-generated token and/or the machine-generated token. The response data in this example includes a set of response tokens. If the redemption component 604 determines that the response data 616 does not include a valid copy of the user-generated token that matches the user-generated token associated with the product 608, the redemption component 604 rejects the recipient's request to pick up the product 608. The request 640 is denied in these examples due to an invalid request token provided by the recipient.

A notification 626 may be sent to the client device 628 in other examples informing the user of the failed attempt to pick up the product 608. The notification 626 may include information associated with the request 640 and/or the reason for rejecting the request 640.

In other examples, one or more of the tokens are invalidated after the third-party recipient picks up the product. The notification 626 in these examples include a notification that one or more of the request tokens are invalidated.

If the response data 616 includes a copy of the user-generated token that matches the user-generated token associated with the transaction for product 608, the redemption component 604 authenticates the recipient 624 as an authorized recipient. The redemption component 604 authorizes the recipient to obtain the product 608 associated with the transaction.

In some examples, the redemption component 604 sends a response 618 to a provider 620 of the product 608. The response 618 includes instructions 622 instructing the provider 620 that the recipient 624 is authorized and/or includes instructions 622 to release the product 608 to the recipient 624. In this manner, the authorization controller validates tokens to authorize a third-party recipient to pick up one or more products autonomously without human personnel.

In some examples, the provider 620 is associate or other personnel at a retail location, such as a store, lumber yard, distribution center, or other location. The instructions 622 are output to the provider 620. The provider 620 releases the product to the recipient 624.

In still other examples, the provider 620 is an automated locker system. The locker system includes a set of one or more locked compartments. In these examples, approving the request 640 includes transmitting the instructions 622 to a client device associated with the locker system. The instructions unlock a first compartment of the one or more locked compartments. The first compartment includes the product 608. When the first compartment is unlocked, the recipient 624 gains access to the product 608.

After the recipient 624 receives the product 608 in other examples, the redemption component 604 invalidates at least one of the user-generated component or the machine-generated token. In other examples, the redemption component 604 invalidates both the user-generated token and the machine-generated token stored by the authentication controller.

The redemption component 604 sends a notification 626 to the purchaser 630 associated with client device 628. The redemption component 604 notifies the purchaser 630 that the recipient 624 had been authorized and/or the recipient 624 has received the product 608.

In this example, the redemption component receives the request 640 from the client device 606. In other examples, the authentication server 600 detects the client device 606 associated with the recipient 624. On detection of the client device, the redemption component 604 transmits one or more prompts to the client device to prompt the third-party to submit the request 640 to claim the product.

In still other examples, if one or more of the request tokens provided by the recipient 624 in the request 640 are invalid, the request 640 is invalidated. The redemption component 604 transmits the instructions 622 to the provider 620. In these examples, the instructions 622 instruct the provider 620 to maintain possession of the product 608.

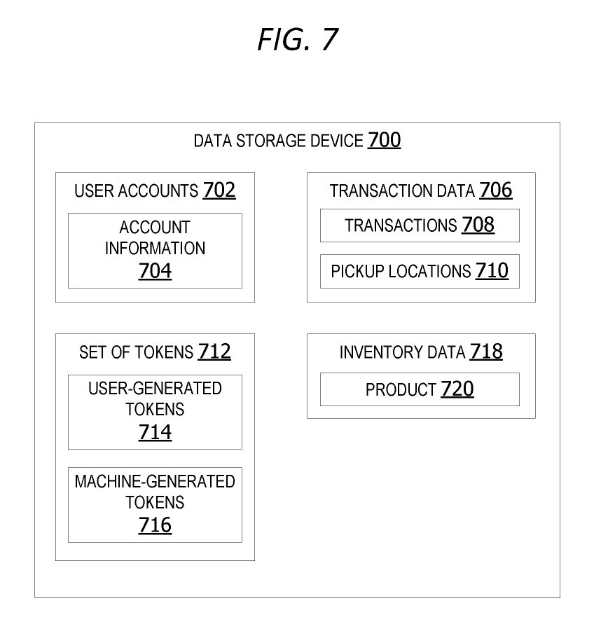

FIG. 7 is an exemplary block diagram illustrating a data storage device for storing authorization data. The data storage device 700 is a set of one or more data storage devices for storing data, such as the data storage device 128 in FIG. 1. The data storage device 700 may include one or more types of data storage devices, such as, for example, one or more rotating disks drives, one or more solid state drives (SSDs), and/or any other type of data storage device.

User accounts 702 includes user account data for one or more users. User account data includes account information 704 for at least one user. The user accounts 702 may include parameters restricting utilization of user account information or other personal identification information in the user-generated token.

Transaction data 706 is data associated with one or more transactions, such as transaction 708. The transaction data 706 may also include one or more pickup locations 710 for one or more products. In other examples, the transaction data 706 may also include product price, product description, or other transaction related data.

The set of tokens 712 is a set of one or more stored tokens. The set of tokens 712 in this non-limiting example includes a user-generated token 714 created by a user associated with a transaction. The set of tokens 712 also includes a machine-generated token 716 created by the authentication controller. The user-generated token 714 in some examples may be encrypted to prevent the system from having access to the original user-generated token, such as encrypted authentication data 136 in FIG. 1.

The data storage device 700 may optionally include inventory data 718. The inventory data 718 may include inventory information associated with one or more products, such as product 720. The inventory data 718 may include the type of product, number of the product in stock, store location of the product 720, and any other inventory information.

In some examples, the authentication controller utilizes the inventory data 718 associated with the product to be picked up with location data for the third-party recipient to pick up the product. The authentication controller analyzes the inventory data 718 and location data to identify one or more potential pickup locations. The authentication controller transmits the identified potential locations to the client device. In some examples, the potential locations are sent to the user via a notification.

FIG. 8 is an exemplary flow chart illustrating operation of the computing device to generate a set of tokens for authenticating a third-party recipient. The process shown in FIG. 8 may be performed by an authentication controller component executing on a computing device, such as, but not limited to, the computing device 102 in FIG. 1 or the authentication server 500 in FIG. 5.

The authentication controller transmits a prompt to a user device associated with a purchaser at operation 802. The prompt is a request for the user to provide authentication information, such as, a user-generated token and/or contact information. The authentication controller sends the prompt in some examples in response to a user action initiating the third-party authentication. An action triggering third-party authentication may include the authentication controller receiving scanning data generated by a scanning device scanning the product to be picked up, a user selecting an option to authenticate a third-party recipient via a user interface, receiving a notification that a third-party recipient is attempting to pick up the product, or any other action to initiate the third-party recipient authentication process.

The authentication controller determines whether a first token is received at operation 804. The first token is a user-generated token, such as the user-generated token 518 in FIG. 5 or the user-generated token 714 in FIG. 7. If no, the authentication controller sends an updated prompt to the user device at operation 802.

When a first token is received at operation 804, the authentication controller compares the first token with account information at operation 806. The account information is information associated with the user, such as the account information 524 in FIG. 5. In some examples, the authentication controller determines if the first token is valid at operation 808. The authentication controller in some examples determines if the token is valid by comparing the first token with the account information to determine if the user-created, first token includes any user account information, such as an email address, birth date, phone number, or other personally identifiable information.

If the first token does include some user account information, the token is invalidated at operation 808. The authentication controller generates a notification at operation 810. The notification is transmitted to the user device at operation 812. The notification may be transmitted to the user device using contact information provided by the purchaser. The notification is transmitted via a communications interface or other output device, such as the communications interface component 130 in FIG. 1. In some examples, the notification is sent via a network, such as the network 114 in FIG. 1.

The authentication controller determines if a new user-generated token to replace the invalid token is received. If not, the authentication controller sends another prompt to the user device requesting the user-generated token at operation 802. The authentication controller executes operations 802 through 812 until a valid user-generated token is received at operation 804.

If the first token is determined to be valid at operation 808, the authentication controller generates a second token at operation 814. The second token is a token created by the registration component, such as the machine-generated token 528 in FIG. 5 or the machine-generated token 716 in FIG. 7. The authentication controller transmits the second token to another user device associated with the third-party recipient using the contact data at operation 816. The second token is transmitted to the user and/or the third-party using the contact data. The contact data is provided by the purchaser. The process terminates thereafter.

While the operations illustrated in FIG. 8 are performed by an authentication server or other computing device, aspects of the disclosure contemplate performance of the operations by other entities. For example, a cloud service may perform one or more of the operations.

FIG. 9 is an exemplary flow chart illustrating operation of the computing device to replace a set of tokens for authenticating a third-party recipient. The process shown in FIG. 9 may be performed by an authentication controller component executing on a computing device, such as, but not limited to, the computing device 102 in FIG. 1 or the authentication server 500 in FIG. 5.

The authentication controller receives a request for a replacement token at operation 902. The request is received from a user device associated with a user that ordered a product to be picked up by a third-party recipient. The user device is a computing device, such as a device in the set of client devices 122 in FIG. 1, the client device 516 in FIG. 5, or the client device 628 in FIG. 6.

The authentication controller determines whether a replacement token is received at operation 904. The replacement token is a second user-generated token created by the purchaser to replace an original, first user-generated token. The replacement token is received from the user device associated with the purchaser. If no, the authentication controller outputs a prompt to the user device at operation 906. The prompt is a request for the user to provide a replacement user-generated token.

If a replacement token is received, the authentication controller invalidates the original tokens at operation 908. The original tokens include the original, user-generated token and the original machine-generated token for a given transaction. The authentication controller identifies the replacement token as the first token at operation 910. The first token is the new user-generated token. The authentication controller generates a replacement second token at operation 912. The replacement second token is a new machine-generated token. The authentication controller transmits the replacement second token using the contact data at operation 914. The replacement second token is transmitted to the user and/or the third-party recipient using contact data provided by the user. The process terminates thereafter.

While the operations illustrated in FIG. 9 are performed by an authentication server or other computing device, aspects of the disclosure contemplate performance of the operations by other entities. For example, a cloud service may perform one or more of the operations.

FIG. 10 is an exemplary flow chart illustrating operation of the computing device to generate encrypted authentication data for authenticating a third-party recipient. The process shown in FIG. 10 may be performed by an authentication controller component executing on a computing device, such as, but not limited to, the computing device 102 in FIG. 1 or the authentication server 500 in FIG. 5.

The process begins by receiving authentication information from a user at operation 1002. The authentication information may include at least one user-generated token, such as the user-generated token 118 in FIG. 1, the token 518 in FIG. 5, or the user-generated tokens 414 in FIG. 4. The user-generated token is compared to account information for the user at operation 1004. If the user-generated token is not valid at operation 1006, a notification is transmitted to the user at operation 1008. The notification in some examples indicates the user-generated token is invalid and/or prompts the user to create a new, different user-generated token. The process terminates thereafter.

If the user-generated token is valid at operation 1006, a machine-generated token is created at operation 1010. The machine-generated token is created by an authentication controller, such as the authentication controller 116 in FIG. 1, authentication application 126 in FIG. 1, authentication controller 502 in FIG. 5, or authentication controller 602 in FIG. 6.

Encrypted authentication data is generated at operation 1012. The encrypted authentication data includes the user-generated token and the machine-generated token. The encrypted authentication data is stored on a data storage device at operation 1014. The data storage device may be any type of device for storing data, such as, the data storage device 128 in FIG. 1 or the data storage device 700 in FIG. 7.

While the operations illustrated in FIG. 10 are performed by an authentication server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

FIG. 11 is an exemplary flow chart illustrating operation of the computing device to authenticate a third-party recipient using a set of tokens. The process shown in FIG. 11 may be performed by an authentication controller component executing on a computing device, such as, but not limited to, the computing device 102 in FIG. 1 or the authentication server 600 in FIG. 6.

The authentication controller receives a pickup request at operation 1102. The pickup request is a request from a third-party to pick up a product, such as the request 340 in FIG. 3. The request includes a set of one or more request tokens. The authentication controller compares the set of request tokens with encrypted authentication data to determine whether to approve the request at operation 1104. The set of request tokens in this example includes a first token and a second token. In some examples, the encrypted authentication data is obtained from a data storage device, such as the data storage device 128 in FIG. 1 or the data storage device 700 in FIG. 7.

The authentication controller determines whether to approve the request at operation 1106. The authentication controller in some examples determines whether to approve the request by comparing the user-generated token and the machine-generated token in the encrypted authentication data with the first token and the second token in the set of request tokens. If the request tokens match the machine-generated token and the user-generated token, the request is approved. If either the user-generated token or the machine-generated token in the encrypted authentication data does not match one of the tokens in the request, the request is not approved.

If the request is not approved at operation 1106, the authentication controller rejects the request at operation 1108. The authentication controller sends a notification to the user at operation 1110. The notification in some examples includes an alert that a third-party attempted to pick up the product with one or more invalid tokens. The process terminates thereafter.

Returning to operation 1106, if the request is approved, the authentication controller sends instructions to release the product at operation 1112. The tokens are invalidated at operation 1114 upon release of the product to the third-party recipient. The authentication controller invalidates the tokens when the product is released to the third-party recipient to prevent future pick up attempts for the same product. The process terminates thereafter.

While the operations illustrated in FIG. 11 are performed by an authentication server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

### Additional Examples

In one example, a customer purchases a product through an online portal associated with a retailer, distributor, manufacturer or other provider of products. This may be performed online or in a physical store. The authentication controller processes the order and create the receipt for the customer. The customer is then presented a link to the receipt and the option to designate a third-party recipient to pick up the purchased product/merchandise. The customer will provide the initial required information of a user-generated token, such as, but not limited to, a passcode. The authentication controller creates a machine-generated token, such as a QR code, based on a globally unique identifier (GUID) and/or other pieces of the order information. The authentication controller encrypts the user-generated token. The authentication controller stores both tokens in a database. The tokens are provided to the third-party recipient by the customer or by the authentication controller. The tokens may be transmitted by email, text message, a user account or any other messaging platform. The customer can change the selected third-party recipient by going through the online portal and updating the selected third-party.

In another example, when the third-party recipient attempts to pick up the merchandise at any approved pickup site, such as but not limited to, a store or a locker, the third-party presents the machine-generated token to be scanned at an input/output device. The authentication controller checks whether the machine-generated token is still valid. If it is valid, the authentication controller prompts the third-party to enter in the user-generated token. The third-party enters the user-generated token, such as a passcode, on any device. The device may include a touch screen device, keyboard, store system keypad, or any other input/output device. The authentication controller validates the token against the encrypted value stored in the database. If the user-generated token is valid, the authentication controller notifies an associate and/or the third-party via a client device screen. The third-party is provided with the ordered merchandise. This can be done by alerting the associate to give the product to the third-party or by opening the correct locker. The authentication controller invalidates the machine-generated token to ensure it cannot be used again.

The authentication controller, in other examples, sends a notification to the original purchaser following release of the product to the third-party recipient. The notification alerts the purchaser that the product has been picked up by the third-party recipient. The notification may also inform the purchaser that the tokens have been invalidated following release of the product to ensure the same user-generated token is not used again.

In another example, a customer buys a product online. The authentication system processes the order and creates a receipt. If the customer elects to have a third-party recipient pick up the product, the customer provides a user-generated token, such as a passcode. The authentication controller creates a machine-generated token, such as a QR code. The machine-generated token is sent to the third-party by the customer or by the authentication controller. When the third-party recipient requests pick up of the product, the third-party recipient provides the user-generated token and the machine-generated token. The authentication controller validates the tokens against one or more encrypted tokens. If both tokens are valid, the authentication controller approves the request. The product is given to the third-party recipient. After pickup, the tokens associated with the order are invalidated to prevent another person from attempting to pick up the product again.

The third-party recipient in some examples presents the machine-generated token, such as a QR code, to be scanned by an associated at a pickup location. The authentication controller verifies that the machine-generated token is still valid. If it is invalid, the system notifies the third-party and/or the original purchaser that the machine-generated token is invalid. If both tokens are valid, the authentication controller validates the request and releases the product to the third-party recipient.

In other examples, a user may authorize pick up of a product by a third-party based on an existing, outstanding order either at purchase time or a later time. An authorization for a third-party to pick up a product may be created, canceled, and/or overridden by the user until the product is picked up.

The user does not identify a specific third-party recipient in some examples. The authentication server does not identify the authorized person. Instead, the system only authorizes the tokens. If a third-party presents valid tokens, the third-party is authorized to obtain the product without requiring any personally identifiable information for the third-party or the customer/purchaser of the product.

In some examples, the authentication controller encrypts the stored copy of the user-generated token. The encryption prevents the user-generated token from being known by the authentication server. This improves security of the tokens.

The user-generated token may be transmitted to the authentication controller via a separate communication. For example, the token may be sent via email, phone, BLUETOOTH, a network connection, short message service (SMS), or any other communication device.

In still other examples, one or more of the tokens are invalidated after a predetermined, threshold time-period has passed. In still other examples, one or more of the tokens are invalidated upon cancellation of the original order by the original purchaser.

Alternatively, or in addition to the other examples described herein, examples include any combination of the following:
storing encrypted authentication data on a data storage device associated with the computing device, the encrypted authentication data comprising the first token and the second token;
retrieving the first token and the second token from the encrypted authentication data on the data storage device on receiving the request;
comparing the set of request tokens to the first token and the second token to determine whether to approve the request;
analyzing transaction data associated with the transaction to identify the first client device associated with the user;
transmitting, to the client device, one or more communications to prompt the user to provide the authentication information;
on condition that the set of request tokens does not correspond to the stored set of tokens in the encrypted authentication data, rejecting the request and transmitting a notification to the first client device notifying the user of the rejected request to claim the product;
transmitting, to the first client device, a first communication to prompt the user to provide the first token;
receiving the first communication including the first token from the first user device;
transmitting, to the second client device, a second communication requesting the contact information for the third-party recipient;
receiving a second communication from the second client device including the contact information;
on approving the request, transmitting instructions to a provider of the product to release the product to the third-party recipient;
identifying one or more user accounts associated with one or more of the user or the third-party recipient;
extracting the account information from the one or more user accounts;
on condition of the first user-generated token corresponds to at least a portion of the account information, rejecting the user-generated token;
on condition that the first user-generated token does not correspond to any portion of the account information, identifying the first user-generated token as a valid first token;
on condition that the first user-generated token corresponds to any portion of the account information, prompting the user to provide a second user-generated token, the second user-generated token is different than the first user-generated token;
on condition that the second user-generated token does not correspond to the account information, identifying the second user-generated token as a valid first token;
on condition that the first user-generated token or the second user-generated token is a valid first token, creating a machine-generated token, wherein the machine-generated token is the second token;
transmitting, to the first client device associated with the user, an instruction to provide the first token to the third-party recipient;
receiving a request to identify one or more alternate recipients;
transmitting, to one or more client devices associated with the one or more alternate recipients, the second token;
receiving a request to identify a replacement recipient, the request including a replacement first token associated with the transaction;
generating a replacement second token, by the computing device;
invalidating the first token and the second token;
encrypting the replacement first token and the replacement second token to form replacement authentication data;
on receiving the request, comparing a set of request tokens extracted from the request with the replacement authentication data to determine whether to approve the request;
receiving a request to generate a replacement second token associated with the transaction;
processing the request to generate the replacement second token, transmit the replacement second token to the second user device using the contact data, and replace the original second token with the replacement second token such that the original second token is invalidated and the replacement second token is encrypted and stored as the second token in the encrypted authentication data, wherein the encrypted authentication data comprises the encrypted replacement second token and the encrypted original first token;
receiving a request to generate a replacement second token associated with the transaction, the request including replacement contact data associated with a replacement recipient;
processing the request to obtain a replacement first token, validate the replacement first token using the account information, generate the replacement second token, transmit the replacement second token to a third user device associated with the replacement recipient using the replacement contact data, invalidate the original first token and the original second token, and update the encrypted authentication data with the replacement first token and the replacement second token such that the updated encrypted authentication data comprises the replacement first token and the replacement second token;
identifying the second client device associated with the third-party recipient using the contact data;
communicating with the second client device to obtain location data associated with the third-party recipient;
identifying inventory data associated with the product;
based on the location data and the inventory data, identifying one or more potential pickup locations;
transmitting, to the second client device, a notification identifying the one or more potential pickup locations.
identifying the second client device associated with the third-party recipient using the contact data;
upon detecting the second client device, transmitting, to the second client device, one or more prompts for the third-party recipient to submit the request to claim the product;
invalidating one or more of the first token or the second token upon approving the request;
transmitting, to the first client device associated with the user, a notification that the one or more of the first token or the second token are invalidated;
wherein approving the request comprises transmitting, to a client device associated with a locker system including one or more compartments, an instruction to unlock a first compartment of the one or more compartments, the first compartment associated with the product;
generating an instruction to a computing device associated with a provider of the product to maintain possession of the product on condition that one or more of the first token or the second token in the set of request tokens are not valid;
transmit, to a first client device, a first prompt of the one or more prompts;
receive, from the first client device, a first communication including the user-generated token;
transmit, to one of the first client device or a second client device, a second prompt of the one or more prompts;
receive, from the one of the first client device or the second client device, a second communication including the contact data;
identify a user account associated with the first transaction, the user account comprising account information;
compare a proposed user-generated token with the account information to determine whether the proposed user-generated token corresponds to at least a portion of the account information;
on condition that the proposed user-generated token corresponds to at least the portion of the account information, reject the proposed user-generated token, and generate a prompt to provide another user-generated token.

At least a portion of the functionality of the various elements in FIG. 1, FIG. 2, FIG. 3, FIG. 4, FIG. 5, FIG. 6, and FIG. 7 may be performed by other elements in FIG. 1, FIG. 2, FIG. 3, FIG. 4, FIG. 5, FIG. 6, and FIG. 7 or an entity (e.g., processor, web service, server, application program, computing device, etc.) not shown in FIG. 1, FIG. 2, FIG. 3, FIG. 4, FIG. 5, FIG. 6, and FIG. 7.

In some examples, the operations illustrated in FIG. 8, FIG. 9, FIG. 10 and FIG. 11 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform tasks or implement abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for administering a pickup program. For example, the elements illustrated in FIG. 1, FIG. 2, FIG. 3, and FIG. 4, such as when encoded to perform the operations illustrated in FIG. 5, FIG. 6, FIG. 7, and FIG. 11, constitute exemplary means for prompting a user associated with a transaction to provide information for authenticating a recipient of a product associated with the transaction; exemplary means for receiving the information for authenticating the recipient, the information including a first token associated with the transaction and contact data associated with the recipient; exemplary means for generating a second token associated with the transaction, the second token different from the first token; exemplary means for transmitting the second token using the contact data; exemplary means for identifying a request to claim the product, the request associated with the first token and the second token; and exemplary means for approving the request on condition that the first token and the second token are valid.

In other examples, the elements illustrated in FIG. 1, FIG. 2, FIG. 3, FIG. 4, FIG. 5, FIG. 6, and FIG. 7, such as when encoded to perform the operations illustrated in FIG. 8, FIG. 9, FIG. 10, and FIG. 11, constitute exemplary means for receiving authentication information for authenticating a third-party recipient of a product associated with a transaction from a first user device associated with a user, the authentication information including a first token associated with the transaction and contact data associated with the third-party recipient; exemplary means for comparing the first token to account information associated with the user; exemplary means for rejecting the first token on condition of the first token corresponding to at least a portion of the account information; exemplary means for generating a second token associated with the transaction on condition of the first token not corresponding to any portion of the account information; exemplary means for transmitting the second token to a second client user device associated with the third-party recipient using the contact data; exemplary means for encrypting the first token and the second token to form encrypted authentication data stored on a data storage device associated with the authentication server; exemplary means for extracting a set of request tokens from a request on receiving the request to claim the product associated with the third-party recipient; and exemplary means for approving the request on condition that the set of request tokens correspond to the first token and the second token of the encrypted authentication data.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An item-pickup kiosk for authorizing third-party item pickup requests, the item-pickup kiosk comprising:
a memory;
at least one processor communicatively coupled to the memory;
a data storage device storing data associated with a set of items associated with a set of orders;
an authentication controller implemented on the at least one processor to:
receive a request from a user to obtain a selected item associated with an order in the set of orders, the request comprising a set of request tokens;
compare the set of request tokens with encrypted authentication data associated with the order to determine whether the set of request tokens correspond with a user-generated token and a machine-generated token in the encrypted authentication data;
generate an instruction to release the selected item to the user on condition the set of request tokens correspond with the user-generated token and the machine-generated token; and
output a response rejecting the request to the user via a user interface device on condition the set of request tokens fail to correspond with the user-generated token and the machine-generated token in the encrypted authentication data; and
a set of conveyor belts within the item-pickup kiosk transferring the selected item from a storage compartment within the item-pickup kiosk to a pickup window associated with the item-pickup kiosk on condition the instruction to release the selected item to the user is received from the authentication controller.

2. The item-pickup kiosk of claim 1, further comprising:
the authentication controller implemented on the at least one processor to:
receive information for authenticating a recipient of an item, the item associated with a selected transaction in a plurality of transactions, the information including the user-generated token associated with the selected transaction and contact data associated with the recipient;
transmit the machine-generated token using the contact data;
generating the encrypted authentication data associated with the selected transaction, the encrypted authentication data comprising the user-generated token and the machine-generated token.

3. The item-pickup kiosk of claim 1, further comprising:
a communications interface component implemented on the at least one processor to:
transmit, to a first client device, a prompt requesting the user-generated token from the first client device;
receive, from the first client device, a first communication including the user-generated token;
transmit a second prompt to the first client device or a second client device requesting the contact data associated with the recipient of the selected item; and
receive a second communication including the contact data from the one of the first client device or the second client device.

4. The item-pickup kiosk of claim 1, further comprising:
the authentication controller implemented on the at least one processor to:
identify a user account associated with the order, the user account comprising account information;
compare a proposed user-generated token with the account information to determine whether the proposed user-generated token corresponds to at least a portion of the account information; and
on condition the proposed user-generated token corresponds to at least the portion of the account information, output a notification to a client device associated with at least one user rejecting the proposed user-generated token; and
generate a prompt to the client device requesting a new user-generated token from the user.

5. A computer-implemented method for authorizing third-party item pickup requests, the computer-implemented method comprising:
receiving, by an authentication controller executing on an authentication server, authentication information for authenticating a third-party recipient of an item associated with a transaction from a first client device associated with a user via a network, the authentication information including a first token associated with the transaction and contact data associated with the third-party recipient;
comparing, by the authentication controller, the first token to account information associated with the user;
generating, by the authentication controller, a second token associated with the transaction on condition the first token fails to correspond with at least a portion of the account information, the second token is different than the first token;
transmitting, via a communication interface device, the second token to a second client device associated with the third-party recipient based on the contact data;
on receiving a request to claim the item from the third-party recipient, extracting a set of request tokens from the request; and
releasing the item to the third-party recipient on condition the set of request tokens correspond to the first token and the second token.

6. The computer-implemented method of claim 5, wherein prompting the user comprises:
storing, by a data storage device, encrypted authentication data comprising the first token and the second token;
retrieving the first token and the second token from the encrypted authentication data on the data storage device on receiving the request; and
comparing the set of request tokens to the first token and the second token to determine whether to approve the request.

7. The computer-implemented method of claim 5, wherein prompting the user comprises:
on condition the set of request tokens does not correspond to the first token and the second token, rejecting the request and transmitting a notification to the first client device notifying the user of the rejected request to claim the item.

8. The computer-implemented method of claim 5, further comprising:
releasing a lock on an item storage locker storing the requested item on condition the third-party recipient is approved to retrieve the item.

9. The computer-implemented method of claim 5, further comprising:
transferring the requested item from a storage compartment to a pickup window via a set of robotic arms on condition the third-party recipient is approved to retrieve the item, wherein the item is transferred to the pickup window.

10. The computer-implemented method of claim 5, further comprising:
transferring the requested item from a storage compartment to a pickup window via a set of conveyor belts on condition the third-party recipient is approved to retrieve the item, wherein the item is transferred to the pickup window.

11. The computer-implemented method of claim 5, wherein the first token is a first user-generated token and further comprising:
identifying one or more user accounts associated with one or more of the user or the third-party recipient;
extracting the account information from the one or more user accounts;
on condition of the first user-generated token corresponds to the at least the portion of the account information, rejecting the first user-generated token;
on condition that the first user-generated token does not correspond to any portion of the account information, identifying the first user-generated token as a valid first token;
on condition that the first user-generated token corresponds to the at least the portion of the account information, prompting the user to provide a second user-generated token, the second user-generated token is different than the first user-generated token;
on condition that the second user-generated token does not correspond to the account information, identifying the second user-generated token as a valid second token; and
on condition that the first user-generated token or the second user-generated token is the valid first token, creating a machine-generated token, wherein the machine-generated token is the second token.

12. The computer-implemented method of claim 5, wherein the third-party recipient is an original recipient, and further comprising:
receiving a request to identify a replacement recipient, the request including a replacement first token associated with the transaction;
generating a replacement second token, by the authentication server;
invalidating the first token and the second token;
encrypting the replacement first token and the replacement second token to form replacement authentication data; and
on receiving the request, comparing the set of request tokens extracted from the request with the replacement authentication data to determine whether to approve the request.

13. The computer-implemented method of claim 5, wherein the first token is an original first token and the second token is an original second token and further comprising:
receiving a request to generate a replacement second token associated with the transaction; and
processing the request to generate the replacement second token, transmit the replacement second token to the second client device using the contact data, and replace the original second token with the replacement second token such that the original second token is invalidated and the replacement second token is encrypted and stored on a data storage device as the second token, wherein the encrypted authentication data on the data storage device comprises the replacement second token and the original first token.

14. The computer-implemented method of claim 5, wherein the first token is an original first token and the second token is an original second token, and further comprising:
receiving a request to generate a replacement second token associated with the transaction, the request including replacement contact data associated with a replacement recipient; and
processing the request to obtain a replacement first token, validate the replacement first token using the account information, generate the replacement second token, transmit the replacement second token to a third client device associated with the replacement recipient using the replacement contact data, invalidate the original first token and the original second token, and update encrypted authentication data with the replacement first token and the replacement second token such that the updated encrypted authentication data comprises the replacement first token and the replacement second token.

15. The computer-implemented method of claim 5, further comprising:
identifying the second client device associated with the third-party recipient using the contact data;
communicating with the second client device to obtain location data associated with the third-party recipient;
identifying inventory data associated with the item;
based on the location data and the inventory data, identifying one or more potential pickup locations; and
transmitting, to the second client device, a notification identifying the one or more potential pickup locations.

16. A locker system for authorizing third-party item pickup requests, the system comprising:
a plurality of item storage lockers storing a set of items ready for pickup by at least one user;
a memory;
at least one processor communicatively coupled to the memory;
a data storage device storing data associated with the set of items;
an authentication controller implemented on the at least one processor to:
receive information for authenticating a user for pickup of a selected item stored in at least one item storage locker in the plurality of item storage lockers, the information including a user-generated token associated with a transaction and contact data associated with a recipient;
transmit a machine-generated token using the contact data;
generate encrypted authentication data associated with the transaction, the encrypted authentication data comprising the user-generated token and the machine-generated token;
receive, from a client device, a request to pick up the item, the request comprising a set of request tokens;
compare the set of request tokens with the encrypted authentication data to determine whether the set of request tokens correspond with the user-generated token and the machine-generated token in the encrypted authentication data; and
on condition that the set of request tokens correspond with the user-generated token and the machine-generated token in the encrypted authentication data, unlock the at least one item storage locker in the plurality of item storage lockers.

17. The locker system of claim 16, further comprising:
an authentication server comprising an authentication application implemented on at least one processor to:
transmit, to a first client device, a first prompt requesting the user-generated token;
receive a first communication including the user-generated token;
transmit a second prompt to the first client device; and
receive, from the first client device or a second client device, a second communication including the contact data.

18. The locker system of claim 16, wherein the authentication controller is further implemented on the at least one processor to:
identify a user account associated with the transaction, the user account comprising account information;
compare a proposed user-generated token with the account information to determine whether the proposed user-generated token corresponds to at least a portion of the account information; and
on condition that the proposed user-generated token corresponds to the at least the portion of the account information, reject the proposed user-generated token, and generate a prompt to provide another user-generated token.

19. The locker system of claim 16, wherein the authentication controller further comprises a registration component implemented on the at least one processor to:
identify selection data associated with a desire to participate in a third-party pickup program;
identify the transaction and a first user associated with the selection data;
prompt the first user to provide information for authenticating the recipient of the selected item associated with the transaction;
obtain the information including the user-generated token associated with the transaction and the contact data associated with the recipient;
identify one or more user accounts associated with one or more of the first user or the recipient;
compare the user-generated token with the account information associated with the one or more user accounts to determine whether the user-generated token corresponds to the at least a portion of the account information;
instruct the first user to provide the recipient with the user-generated token;
generate the machine-generated token associated with the transaction; and
utilize the contact data to provide the recipient with the machine-generated token.

20. The locker system of claim 16, wherein the authentication controller further comprises a redemption component implemented on the at least one processor to:
identify the request to pick up the selected item;
determine whether the request is associated with the machine-generated token;
on condition the request is associated with the machine-generated token, prompt a second user associated with the request to provide the user-generated token;
obtain response data associated with the second user;
compare the response data with the user-generated token to determine whether the response data corresponds the user-generated token;
on condition the response data corresponds to the user-generated token, authenticate the second user as the recipient;
authorize the second user to obtain the selected item associated with the transaction;
invalidate one or more of the user-generated token or the machine-generated token; and
notify one or more of the first user or the second user that the one or more of the user-generated token or the machine-generated token are invalidated.
